(19) United States
(12) Patent Application Publication
(10) Pub. No.: US 2006/0048662 A1
(43) Pub. Date: Mar. 9, 2006

(54) Ink composition for ink-jetting upon substrates for a print form, process for producing it and method of preparing a lithographic print form

(75) Inventors: Hans-Erik Hjelmroth, Korsor (DK); Joachim H Spies, Copenhagen (DK); Sten Haustrup, Roskilde (DK); Alex Rorbaek, Jystrup (DK)

Correspondence Address: DARBY & DARBY P.C., P. O. BOX 5257, NEW YORK, NY, 10150-5257, US

(73) Assignee: GLUNZ & JENSEN A/S, Ringsted (DK)

(21) Appl. No.: 10/533,387

(22) PCT Filed: Oct. 27, 2003
(86) PCT No.: PCT/DK03/00724

§ 371 Date: Jul. 20, 2005

(30) Foreign Application Priority Data
Oct. 28, 2002 (DK) PA200201633

(51) Int. Cl. B41N 1/00

(52) U.S. Cl. 101/453

(57) ABSTRACT

A lithographic printing form comprising an ink where said ink comprises a polymer or copolymer having acidic groups where at least one of said groups has been converted to an amide. A method of producing a lithographic printing form comprising the steps of printing upon a substrate with an ink comprising the previously mentioned polymer and drying the substrate. An ink and a process for producing inks comprising a polymer or copolymer with acidic groups, where at least one of said groups has been converted to the corresponding amide; optionally the ink further comprises fatty acids, metals, metal complexes and/or dyes.

### FIELD OF THE INVENTION

This invention relates to an ink for use in the preparation of printing plates and the resulting lithographic printing forms. More particularly the invention relates to a composition comprising a polymeric compound which is suitable for ink-jetting on a substrate which is usually a metal plate but not limited thereto, which, after treatment, can be used as a printing form in lithographic printing.

### BACKGROUND OF INVENTION

There are several types of ink, such as printing inks and inks for preparing printing plates. Printing inks are generally used to print on a final substrate creating the final product. Inks for preparing a printing plate are used at different stages in the printing process and have different requirements. Inks for preparing a printing plate are use on a substrate creating image areas and non-image areas. These areas are later brought into contact with the printing ink in order to transfer the printing ink to the final substrate. This invention relates to inks for preparing a printing plate.

In the offset lithographic printing method a developed planographic printing plate having oleophilic image areas and hydrophilic non-image areas has long been used. When water is applied to such a plate, the water will form a film on the hydrophilic areas, which are the non-image areas of the plate, and the water will contact the oleophilic plate areas in tiny droplets. When an oil-based ink composition is applied to the plate, it will not ink the water film of the non-image, but it will emulsify the water droplets on the water repellant image areas, which then take up ink. The resulting image is transferred, or “offset”, onto a rubber blanket which is then used to print onto a medium such as paper.

The plates used to prepare the printing plate may be, but are not limited to, aluminium plates with different surface treatments. These surfaces can be anodized, grained or silicated in order to obtain a surface having e.g. acidic, amphoteric or alkaline properties. Which plates that is usable depends on the method and/or the composition used to create the oleophilic areas afterwards.

The oleophilic areas can be created by surface treatment with ink, resin, wax, etc. The printing plate is then dried, cured, heated, washed or subjected to other treatment to prepare the final plate.

It is known to print on these plates with different kinds of inks using ink-jetting techniques e.g. piezo, thermal, bubble jet, drop on demand or continuous ink jet. For this purpose, the ink must possess certain characteristics. It must have a surface tension within certain limits. As long as the surface tension composant in the interface of the plate to the ink is less than the surface tension composant in the plane of the interface between plate and air, the ink will spread. If the surface energy is too high, the contact angle, which is given by Young's Equation, will be more than 90°, which will cause the drop to bounce off. Further the plate must have the mandatory parts for creating the oleophilic areas.

U.S. 2002/0109763 A1 discloses the use of boron acids and boron esters as the component of the ink that binds to the surface of the plate. These inks are suitable for oxidized metallic surfaces and particularly anodised aluminium surfaces.

EP 1 157 825 A1 discloses the use of phosporesters as the component that makes the printing plate oleophilic. These inks are also limited to use on an oxidized metallic surface which has preferably been anodised.

EP 1 157 827 A1 discloses the use of heterocyclic compounds as the oleophilizing agent in the ink. These inks are also mainly limited to use on an oxidized metallic surface which has preferably been anodised.

WO0046038 discloses the use of certain polymers and copolymers as the oleophilizing component in an ink composition. It discloses the use of partly or fully neutralized acidic polymers for use on alkaline plates. It further discloses the use of partly or fully neutralized alkaline polymers containing a plurality of tertiary amine groups as a part of the polymer backbone for use on acidic plates.

The previously mentioned inks all have the setback that they are only suitable for certain plates, e.g. acid polymers for alkaline plates and alkaline polymers for acidic plates. It would be a big advantage if one ink could be used on any kind of printing plate.

Furthermore the previous inks have a relatively long drying time. An ink which dries and hardens fast will facilitate the handling of printing plates because they will be less sensitive to shock.

U.S. Pat. No. 6,183,923 B1 discloses an oil based ink used on metal substrates. Further oil soluble dyes are disclosed.

U.S. Pat. No. 5,973,025 discloses an ink comprising a polymer having an amide functionality and a neutralized acid functionality present as a salt. The styrene monomer is not mentioned in this patent and further there is no indication of using such inks in preparation of lithographic printing plates.

EP 1 088 866 A1 discloses an ink comprising a polymer with an amide functionality and a neutralized acid functionality. The use of fatty acids and metal complexes is not disclosed in this application.

The last tree documents disclose printing ink which cannot be associated with the preparation of printing plates.

### SUMMARY OF THE INVENTION

An object of the present invention is to provide a fluid composition which may be used as an ink for ink jetting on all types of plates to produce a printable media. Furthermore it is an object of the invention to provide an ink which dries and hardens fast after it has been applied to the printing plate.

The invention is based on the discovery that amidized acidic polymers and copolymers can bind to all types of plates and that they dry very fast and form integrated structures faster after being sprayed on the plate and subjected to heating. An even better ink is obtained if the amidized acidic polymer is mixed with fatty acids and optionally one or more transition metals preferably in form of a complex. By adding both fatty acids and metal ions to the ink composition containing amidized acidic polymers a particularly suitable ink is obtained.

According to the invention there is provided a lithographic printing form comprising
a substrate, preferably a metal plate, and
an ink comprising a polymer or copolymer with acid groups,
   wherein at least one of said groups has been converted to the corresponding amide.

Further there is provided a method of preparing a lithographic printing form comprising the steps of:
treating a substrate, preferably a metal plate, with an ink comprising a polymer or copolymer with acid groups wherein at least one of said groups has been converted to the corresponding amide;
drying the substrate
optionally heating the substrate.

Further there is provided a process for producing an ink for use in the method comprising the steps of:
a) treating a polymer or a copolymer having acid groups with an amine,
b) adjusting pH to above 7,
c) optionally adding fatty acid, oil or wax,
d) optionally adding one or more transition metals or metal complexes,
e) optionally adding colouring agent
f) optionally heating the ink

At last there is provided an aqueous ink comprising a polymer or copolymer with acid groups wherein at least one of said groups has been converted to the corresponding amid, and which is characterized in that the ink further comprises from 0.001% by weight to saturation of one or more fatty acids and optionally one or more of the following ingredients:
from 0.1 to 20% by weight of a surfactant,
from 0.1 to 20% by weight of a colouring agent,
from 0.001 to 10% by weight of at least one metal or metal complex from the group of transition metals,
from 0.1 to 80% by weight of a surface tension/viscosity modifying agent,
from 0.01 to 20% by weight of hydrofilic additive.

This ink is suitable for ink-jetting.

The invention further comprises the use of an ink according to the invention to prepare a printing plate.

The ink of the invention is suitable for ink jetting in all its forms, e.g. bubble jet, piezo, thermal, drop on demand or continuous ink jet.

The advantage of this invention is that the ink of the invention can be used on almost any metal plate and at least on any aluminium surface. The ink dries fast and has less tendency to generate bubbles in the ink and is therefore particularly suitable in the printing industry.

In one embodiment the ink is water soluble which is desirable due to the resulting cleaner printing methods.

### DETAILED DESCRIPTION OF THE INVENTION

The applicant has discovered that an ink composition comprising a polymer with acid groups, where at least one of said groups has been converted to the corresponding amide, can bind hard enough to both acidic and alkaline metal surfaces to be useful in producing lithografic printing forms. The amine used in the amide can be, but is not limited to, ammonia, alkylamin, dialkylamin and aromatic amines.

It is the acid base equilibrium of the unamidized acid groups and the acid base equilibrium of the amide groups that allow the ink to bind to both acidic and alkaline metal surfaces. At least 3 of the following forms of the substiutents are present at the same time at pH above 7:
COO⁻, COOH, CONR₂, CONR₂H⁺,
   where R independently can be hydrogen, alkyl (branched or unbranched), cycloalkyl or aromatic groups; each group optionally having further substituents.

The ink is suitable for ink-jetting, e.g. bubble jet, piezo, thermal, drop on demand or continuous ink jet. The ink may be further improved by treating it with fatty acids, dyes and/or optionally one or more metals from the group of transition metals preferably in form of a complex.

The dyes are essentially used to show the image areas on the print form. But certain dyes e.g. rhodamine additionally improves the properties of the imaging areas.

The metals or metal complexes improve the solubility of the dyes in water and they stabilize the binding of the dyes to the surface of the printing form. It is not all the dyes that need a metal or metal complex to bind acceptably to the surface of the printing form but there are examples of dyes which do not bind strongly enough to the form without the aid of the metal or metal complex.

The fatty acids improve the oleophilisity of the image areas and thereby the ability to transfer the printing ink to a final substrate resulting in an increased run length of the printing form.

Preferably the polymer or copolymer further comprises a hydrocarbon moiety preferably with one or more double bonds e.g. a copolymer made from styrene and methacrylat.

The Ink

The ink according to the invention comprises a polymer or a copolymer with acid groups. The monomers with the acidic group may be chosen from, but are not limited to, acrylic acid, methacrylic acid, maleic acid, maleic acid anhydride, fumaric acid, fumaric acid anhydride. Further monomers used in the copolymers include, but are not limited to, styrene, sulfonated styrene, vinyl, etc. The polymers may be, but are not limited to, block, graft, random-block or random-graft polymers.

Suitable base for reacting with the acid group to create the amide are ammonia, methyl amine, dimethyl amine, ethyl amine, diethylamine, methylethyl amine, propyl amine, dipropyl amine, isopropyl amine, diisopropylamin, etc. However amines with up to C20 alkyl chains are also usable.

Particularly suited polymers are Joncryl polymers which are styrene-acrylate polymers. Polymers or copolymers with a molar mass above 250 g/mole are suitable. In one embodiment of the invention it is preferred that the average molar mass of the polymer is above 10 000 g/mole, and optimally above 14 000 g/mole, one such polymer being Joncryl 690.

As mentioned, the ink may optionally comprise a fatty acid, a wax or any kind of analog material which binds to the amide. When used, the fatty acid or fatty acid alcohol is present from 0.001% by weight to saturation. The fatty acid may optionally be based on in part or 100% saponified polymer. The fatty acid may be any fatty acid containing 4 to 26 carbon atoms. The fatty acid may be saturated or unsaturated. It may contain one or more additional functional groups besides the acid group. These functional groups may be, but are not limited to, such chosen from the list: amines, imines, esters, ethers, ketones, aldehydes, sulfates, sulfones, sulfides, phosphates and phosphoesters. The fatty acids may be, but are not limited to: lauric, myristic, palmitic, stearic, arachidic, palmitoleic, oleic, linoleic, and linolenic acids. Particularly suited fatty acids are fatty acids extracted from lanolin or derived from hydroxylated lanolin preferred in the form of lanoline oil, lanoline acid or lanolinate alcohols.

In another embodiment waxes are used as a supplement or alternative to the fatty acids. Examples of such suitable waxes are Ritaalfa™ and Ritawax™ which comprise lanolin.

The ink may also comprise any form of organic or non organic oil that binds to the amidized polymer either at the amide bond or at another site of the polymer. Said oils may be chosen from, but are not limited to, silicone oils or ether oils.

In a preferred embodiment the ink also comprises one or more transition metals. When used, the transition metal/metals is/are present in concentrations from 0.001 to 10% by weight.

The ink may further contain from 5 to 90% water.

In another embodiment the starting material, i.e. the polymer or copolymer, may be bought as an amide. The polymer or copolymer is then treated with base to keep the solution alkaline. One or more of the previously mentioned additives is then applied to the mixture as described for the acidic polymer or copolymer.

The ink may be an emulsion or a solution comprising one or more liquids. In a preferred embodiment one of the liquids is water.

After the amidization a base is added to the mixture in order to keep the mixture alkaline, i.e. pH above 7, also in the case where acidic compounds are added to the mixture. Preferably the pH is kept in the range between 7.5 and 8.5. The added base may be any kind of base, but ammonia is preferred, e.g. a 30% aqueous solution of ammonia is preferred.

The resulting ink should have a dynamic viscosity between 1.0 and 15 mPa·s, preferably between 1.5 and 4.5 mPa·s, and optimally between 2.5 and 4.5 mPa·s. Preferably the ink should also have a surface tension between 0.01 and 0.10 N/m, more preferably between 0.02 and 0.06 N/m and most preferably between 0.03 and 0.05 N/m. The surface tension and the dynamic viscosity are adjusted to accurate values within said limits by adding liquids with different surface tensions or by adding surfactants. Said liquids may be, but are not limited to, one or more liquids from the list:

Ethylene glycol monomethyl ether, ethylene glycol dimethyl ether, ethylene glycol monoethyl ether, ethylene glycol diethyl ether, ethylene glycol mono-n-propyl ether, ethylene glycol monoisopropyl ether, ethylene glycol mono-n-butyl ether, ethylene glycol mono-sec-butyl ether, ethylene glycol monoisobutyl ether, ethylene glycol mono-tert-butyl ether, ethylene glycol mono-n-amyl ether, ethylene glycol mono-n-hexyl ether, propylene glycol monomethyl ether, propylene glycol dimethyl ether, propylene glycol monoethyl ether, propylene glycol diethyl ether, propylene glycol mono-n-propyl ether, propylene glycol monoisopropyl ether, propylene glycol mono-n-butyl ether, propylene glycol mono-sec-butyl ether, propylene glycol monoisobutyl ether, propylene glycol mono-tert-butyl ether, diethylene glycol monomethyl ether, diethylene glycol dimethyl ether, diethylene glycol monoethyl ether, diethylene glycol diethyl ether, diethylene glycol mono-n-propyl ether, diethylene glycol mono-iso-propyl ether, diethylene glycol mono-n-butyl ether, diethylene glycol mono-sec-butyl ether, diethylene glycol monoisobutyl ether, diethylene glycol mono-tert-butyl ether, dipropylene glycol monomethyl ether, dipropylene glycol monoethyl ether, dipropylene glycol mono-n-propyl ether, dipropylene glycol mono-n-butyl ether, polyethylene glycol monopropyl ether, polyethylene glycol monobutyl ether, ethylene glycol, propylene glycol, any alcohol with 1 to 6 carbon atoms e.g methanol, ethanol, n-propanol, 2-propanol etc. It is known from the literature that these compounds will change the surface tension and the viscosity of an aqueous solution. The liquids may be present in amounts from 0.1 to 80% by weight.

The surfactants may be, but are not limited to, quaternary ammonium salts, ammonium salts, sulfonates, and sulfonic acids. They may be present in amounts from 0.1 to 20% by weight

The ink in all of its embodiments forms spots after drying and heating to more than 120° C., preferably heated to between 170° C. and 220° C., and optimally heated to between 190° C. and 210° C. These spots form an oleophilic, and preferably hydrophobic, structure which adheres to the substrate of the print form. The dried and hardened ink becomes the printing ink receptive layer of the resulting print form. The ink is oleophilic, and therefore the printing ink adheres to the areas where the ink is deposited on the metal surface (the image areas). On the non-image areas the surface remains hydrophilic, and only water will adhere to those regions. In this application “image” is the term used for both letters and pictures of the lithographic print form. It is on the image that the printing ink is adsorbed.

The ink preferably has a wetting angle between 15° and 80°, more preferably between 15° and 65°.

In a preferred embodiment the ink also contains between 0.1 and 20% by weight of a colouring agent, and optimally the colouring agent is a dye soluble in the mixture. Other suitable colour agents are metal complex dyes, most preferably transition metal complexes.

Anionic dyes are soluble in water or can be made soluble in water and are therefore suitable for the invention. Further cationic dyes can be used when the can be made water soluble optionally by means of a small amount of non-polar liquids. More preferable are those dyes that form bondings with the polymer and/or the substrate and/or are carrying a strong hydrophobic part. Especially preferred dyes are Rhodamine B, Gallocyanine, Methyl green, Sudan IV, Erythrosine B, Crystal Violet.

The used amount or type of dye, fatty acid, metal complex and wax depends on the amount of acid groups which have been converted to amide groups. Therefore by changing the degree of amidization it is possible to use a particularly desired dye or fatty acid which might not be used otherwise.

The resulting print form should be able to carry out many runs, preferably it should be able to achieve run lengths of more than 50 000 copies, optimally more than 100 000 copies.

Process for Producing the Ink

The ink is produced by taking a polymer or copolymer prepared from the previously mentioned monomers, preferably of the type N-p-styrene-N-p-acryl and most preferably a Joncryl 690, and mixing it with an aqueous solution of NH₃. The mixture is heated to between 65° C. and 180° C., preferably between 70° C. and 150° C., and optimally about 80° C. Optionally a fatty acid, a wax and/or an oil of the previously mentioned kind is added together with a strong base. The mixture is kept heated and the method may optionally take place under pressure, from 0.1 to 150 atm. One or more metals from the group of transition metals may further be added to the mixture.

This base-mixture is diluted with an equal amount of water. Further, 0.1 to 5% of an aqueous NH₃ solution is added, preferably a 30% solution, and optionally a colour. Enough ammonia is added to keep the solution alkaline, even if the colour is acidic, i.e. the solution is kept at a pH>7, and preferably a pH between 7.5 and 8.5.

In an alternative procedure soaps or polysoaps of fatty acids and/or oils and/or soap-analogs are added directly to the method between the polymer and ammonia. These soaps join with the acyl part of the amide or with other functional groups of the polymer. Hereby micelle-like polymer-amide-soap-complexes are formed which are partly soluble in water. After being placed on a substrate such as a metal plate, preferably made of aluminium and being dried and baked at temperatures above 120° C., preferably between 170° C. and 220° C., and optimally between 190° C. and 210° C., the resulting mixture creates an interlinking cross-binded network. This network binds strongly to the surface of the substrate, and the resulting product is the lithographic print form. During the heating the ink is baked into the surface of the substrate.

Suitable ink compositions are given in the table below:

| | Ink no. | | | | | | |
|---|---|---|---|---|---|---|---|
| | 1 | 2 | 3 | 4 | 5 | 6 | 7 |
| Sudan IV | 1.3 | 1.3 | | | 1.5 | | |
| Chromidye Ethyl Red | | | | 4.3 | | 4.3 | |
| Chromidye Rodamine B | | | 25 | | | | 25 |
| Ethanol | 10 | 8 | 25 | 23 | 10 | 23 | 25 |
| Dest. Water | 57.9 | 47.5 | 16 | 62.9 | 57.9 | 62.9 | 15.9 |
| Dowanol | 14 | 12 | 25 | | 14 | | 25 |
| Ammonia | 2 | 1.6 | 2 | 3.3 | 2 | 3.3 | 2 |
| “Joncryl ® 690” | 14.7 | 12 | 7 | 6.4 | 14.5 | 6.4 | 7 |
| Lanoline | | 15.2 | 5 | | | | |
| NaOH | | 2.4 | | | | | |
| Neutral lanoline soap | 0.1 | | | 0.1 | 0.1 | 0.1 | 0.1 |

The amounts are % by weight. The base used may be replaced by any base and the soap may be replaced by any soap. Neutral soaps are preferred.

Process of Preparing the Printing Form

An ink according to the invention is applied to the substrate by any kind of ink-jetting. The substrate is then dried and baked at temperatures above 120° C., preferably between 170° C. and 220° C., and optimally between 190° C. and 210° C. The dried ink is the printing image of the print form.

### EXAMPLE 1

The amidized Joncryl 690 is prepared by mixing 25 g water-free crystalline random poly-styrene-acryl from Johnson Polymers Inc. in 50 g H₂O with 9 g 30% ammonia with stirring at 80° C. for approximately 30 min. Subsequently, the mixture is diluted with the same amount of water and at least enough ammonia to keep the mixture alkaline (pH>7) even with addition of acidic components.

### EXAMPLE 2

An ink as described in Example 1, where 14 g dowanol is mixed with the polymer and the ammonium before stirring.

### EXAMPLE 3

To the amidized Joncryl from example 1 hydroxylated lanoline, lanoline oil, lanoline acid or lanolinate alcohols are added to saturation. Hereby complexes of styrene-acryl-amide-fatty acid are created. In these complexes the lanoline oil is only partly soluble in alkaline water solutions and therefore forms small micelles. This mixture is then sprayed on to the plate, whereafter the plate is dried and baked at temperatures above 150° C. During the heating the mixture forms a cross-linking network which binds to aluminium plates. The binding is strong enough to use the aluminium plate as a print form for lithographic printing.

### EXAMPLE 4

To the mixture of example 2 chromium (III) complexes are added in an amount of up to 5% by weight of chromium. This mixture is sprayed on an aluminium plate which is dried and baked as previously mentioned. The network of metalstyrene-acryl-amide-fatty acid now binds even stronger to the aluminium plate. The resulting print form can therefore be used to extended run lengths, more than 100 000 copies.

### EXAMPLE 5

A preferred ink composition is 100 g of the amidized Joncryl 690 mixed with 20 g EtOH and 2 g Sudan IV.

### EXAMPLE 6

Inks from permanent penol markers 777 and 750 have been painted on aluminium surfaces. Said inks comprise acrylates, Fe-, Zi-, Va-, Mn-, Mb-, Co-, Cr- and Ti-complexes. The complexes of acrylate and the metals bind particularly hard to the aluminium surface, and the alkyl part of the acrylates then provides the oleophilic and hydrophobic areas necessary for use in producing a print form.

1. A lithographic printing form comprising
a) a substrate, and
b) an ink comprising a polymer or copolymer with acid groups,
wherein at least one of said groups has been converted to the corresponding amide.

2. The lithographic printing form of claim 1, wherein the amide is made from an amine selected from the group consisting of ammonia, an alkyl amine and a dialkyl amine.

3. The lithographic printing form of claim 1, wherein the ink is dried ink or baked ink.

4. The lithographic printing form of claim 1, wherein the polymer or copolymer is composed of monomers selected from the group consisting of acrylic acid, methacrylic acid, maleic acid, maleic acid anhydride, fumaric acid, fumaric acid anhydride, styrene, sulfonate styrene, and vinyl.

5. The lithographic printing form of claim 1, wherein the polymer or copolymer has an average molar mass greater than 250 g/mole.

6. The lithographic printing form of claim 1, wherein the ink further comprises at least one component selected from the group consisting of
a) from 0.1% to 20% by weight of a surfactant,
b) from 0.1% to 20% by weight of a coloring agent,
c) from 0.001% by weight to saturation of one or more fatty acids, oils or alcohols,
d) from 0.001% to 10% by weight of at least one transition metal or transition metal complex,
e) from 0.1% to 80% by weight of a surface tension/viscosity modifying agent,
f) from 0.01% to 20% by weight of a hydrophilic additive, and
g) from 5% to 90% by weight of water.

7. The lithographic printing form of claim 6, wherein said transition metal or transition metal complex is selected from the group consisting of chromium, titanium, iron, molybdenum, manganese, cobalt, zirconium, vanadium and complexes thereof.

8. The lithographic printing form of claim 1, wherein the substrate is an aluminum plate.

9. A method of preparing a lithographic printing form comprising the steps of:
a) treating a substrate with an ink comprising a polymer or copolymer with acid groups wherein at least one of said acid groups has been converted to the corresponding amide; and
b) drying the substrate.

10. The method of claim 9, wherein the amide is made from an amine selected from the group consisting of ammonia, an alkyl amine and a dialkyl amine.

11. The method of claim 9, wherein the polymer or copolymer is composed of monomers selected from the group consisting of acrylic acid, methacrylic acid, maleic acid, maleic acid anhydride, fumaric acid, fumaric acid anhydride, styrene, sulfonate styrene, and vinyl.

12. The method of claim 9, wherein the polymer or copolymer has an average molar mass greater than 250 g/mole.

13. The method of claim 9, wherein the ink further comprises at least one component selected from the group consisting of
a) from 0.1% to 20% by weight of a surfactant,
b) from 0.1% to 20% by weight of a coloring agent,
c) from 0.001% by weight to saturation of one or more fatty acids, oils or alcohols,
d) from 0.001% to 10% by weight of at least one transition metal or transition metal complex,
e) from 0.1% to 80% by weight of a surface tension/viscosity modifying agent,
f) from 0.01% to 20% by weight of a hydrophilic additive, and
g) from 5% to 90% by weight of water.

14. The method of claim 13, wherein said transition metal or transition metal complex is selected from the group consisting of chromium, titanium, iron, molybdenum, manganese, cobalt, zirconium, vanadium and complexes thereof.

15. The method of claim 37, wherein the substrate is heated to above 150° C.

16. The method of claim 9, wherein the substrate is an aluminum plate.

17. The method of claim 9 wherein the ink is dried onto or baked into the substrate.

18. A process for producing an ink for use in the method of claim 9 comprising the steps of:
a) treating a polymer or a copolymer having acid groups with an amine, and
b) adjusting the pH to above 7.

19. The process of claim 18, wherein the amine is selected from the group consisting of ammonia, an alkyl amine and a dialkyl amine.

20. The process of claim 18, wherein the pH is adjusted to between 7.5 and 8.5

21. The process of claim 18, wherein the polymer or copolymer is composed of monomers selected from the group consisting of acrylic acid, methacrylic acid, maleic acid, maleic acid anhydride, fumaric acid, fumaric acid anhydride, styrene, sulfonate styrene, and vinyl.

22. The process of claim 45, wherein the mixture is heated to between 65° C. and 180° C.

23. The process of 42, wherein the fatty acid is selected from the group consisting of lauric acid, myristic acid, palmitic acid, stearic acid, arachidic acid, palmitoleic acid, oleic acid, linoleic acid, linolenic acids, lanoline and lanolinate-alcohols.

24. The process of claim 23, wherein the fatty acid is extracted from lanolin or lanolinate-alcohols.

25. The process of claim 43, wherein said transition metal or transition metal complex is selected from the group consisting of chromium, titanium, iron, molybdenum, manganese, cobalt, zirconium and vanadium.

26. The process of claim 44, wherein the coloring agent is a dye selected from the group consisting of Rhodamine B, Gallocyanine, Methyl green, Sudan IV, Erythrosine B and Crystal Violet.

27. An aqueous ink comprising
a) a polymer or copolymer with acid groups, wherein at least one of said acid groups has been converted to the corresponding amide, and
b) from 0.001% by weight to saturation of one or more fatty acids.

28. The aqueous ink of claim 27, wherein said fatty acid is extracted from lanolin or derived from hydroxyleate lanolin.

29. The aqueous ink of claim 48 wherein said transition metal or transition metal complex is selected from the group consisting of chromium, titanium, iron, molybdenum, manganese, cobalt, zirconium and vanadium.

30. The aqueous ink of claim 48, wherein said coloring agent is a dye selected from the group consisting of Rhodamine B, Gallocyanine, Methyl green, Sudan IV, Erythrosine B and Crystal Violet.

31. The aqueous ink of claim 48, wherein the additive is selected from the group consisting of: ethylene glycol monomethyl ether, ethylene glycol dimethyl ether, ethylene glycol monoethyl ether, ethylene glycol diethyl ether, ethylene glycol mono-n-propyl ether, ethylene glycol monoisopropyl ether, ethylene glycol mono-n-butyl ether, ethylene glycol mono-sec-butyl ether, ethylene glycol monoisobutyl ether, ethylene glycol mono-tert-butyl ether, ethylene glycol mono-n-amyl ether, ethylene glycol mono-n-hexyl ether, propylene glycol monomethyl ether, propylene glycol dimethyl ether, propylene glycol monoethyl ether, propylene glycol diethyl ether, propylene glycol mono-n-propyl ether, propylene glycol monoisopropyl ether, propylene glycol mono-n-butyl ether, propylene glycol mono-sec-butyl ether, propylene glycol monoisobutyl ether, propylene glycol mono-tert-butyl ether, diethylene glycol monomethyl ether, diethylene glycol dimethyl ether, diethylene glycol monoethyl ether, diethylene glycol diethyl ether, diethylene glycol mono-n-propyl ether, diethylene glycol mono isopropyl ether, diethylene glycol mono-n-butyl ether, diethylene glycol mono-sec-butyl ether, diethylene glycol monoisobutyl ether, diethylene glycol mono-tert-butyl ether, dipropylene glycol monomethyl ether, dipropylene glycol monoethyl ether, dipropylene glycol mono-n-propyl ether, dipropylene glycol mono-n-butyl ether, polyethylene glycol monopropyl ether, polyethylene glycol monobutyl ether, ethylene glycol, propylene glycol, and a C₁-C₆ alcohol.

32. The aqueous ink of claim 48, wherein said aqueous ink has a surface tension between 0.01 N/m and 0.10 N/m.

33. The lithographic printing form of claim 1 wherein the substrate is a metal plate.

34. The lithographic printing form of claim 5, wherein the polymer or copolymer has an average molar mass greater than 10,000 g/mole.

35. The lithographic printing form of claim 34, wherein the polymer or copolymer has an average molar mass greater than 14,000 g/mole.

36. The method of claim 9, wherein the substrate is a metal plate.

37. The method of claim 9, further comprising after step b) the step of c) heating the substrate.

38. The method of claim 12, wherein the polymer or copolymer has an average molar mass greater than 10,000 g/mole.

39. The method of claim 38, wherein the polymer or copolymer has an average molar mass greater than 14,000 g/mole.

40. The method of claim 15, wherein the substrate is heated to a temperature between 170° C. and 220° C.

41. The method of claim 40, wherein the substrate is heated to a temperature between 190° C. and 210° C.

42. The method of claim 18, further comprising after step b) the step of c) adding fatty acid, oil or wax.

43. The method of claim 18, further comprising after step b) the step of d) adding at least one transition metal or transition metal complex.

44. The method of claim 18, further comprising after step b) the step of e) adding a coloring agent.

45. The method of claim 18, further comprising after step b) the step of f) heating the ink.

46. The process of claim 22, wherein the ink is heated to a temperature between 70° C. and 150° C.

47. The process of claim 46, wherein the ink is heated to a temperature of 80° C.

48. The aqueous ink of claim 27, further comprising at least one component selected from the group consisting of:
c) from 0.1% to 20% by weight of a surfactant;
d) from 0.1% to 20% by weight of a coloring agent;
e) from 0.001% to 10% by weight of at least one transition metal or transition metal complex;
f) from 0.1% to 80% by weight of a surface tension/viscosity modifying agent; and
g) from 0.01% to 20% by weight of a hydrophilic additive.

49. The aqueous ink of claim 28 wherein the hydroxyleate lanolin is selected from the group consisting of lanoline oil, lanoline acid and lanolinate alcohols.

50. The aqueous ink of claim 32, wherein said aqueous ink has a surface tension between 0.02 N/m and 0.06 N/m.

51. The aqueous ink of claim 50, wherein said aqueous ink has a surface tension between 0.03 N/m and 0.05 N/m.
